(19) United States
(12) Patent Application Publication
(10) Pub. No.: US 2003/0140174 A1
(43) Pub. Date: Jul. 24, 2003

(54) Method for generating application for information processing apparatus and image forming apparatus

(76) Inventors: Tsutomu Ohishi, Fukuoka (JP); Katsuhiko Nakagawa, Fukuoka (JP); Hiroyuki Tanaka, Fukuoka (JP); Yuuko Sugiura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/334,828

(22) Filed: Jan. 2, 2003

(30) Foreign Application Priority Data
Jan. 8, 2002 (JP) 2002-001562
Dec. 26, 2002 (JP) 2002-377971
Dec. 26, 2002 (JP) 2002-377972

(51) Int. Cl. G06F 15/163; G06F 9/54; G06F 9/00

(52) U.S. Cl. 709/310; 709/107

(57) ABSTRACT

A method for generating a new application used in an image forming apparatus is provided, in which the image forming apparatus includes hardware resources, an application and a control service, the method includes: a compile step of compiling a source file of the new application in which source code for calling a wrapping function is described so as to generate an object file, wherein the wrapping function performs processes relating to the control service on behalf of the new application; and a link step of linking the object file with a wrapping function library that includes the wrapping function so as to generate an executable program of the new application.

### BACKGROUND OF THE INVENTION

1. Field of the Invention

The present invention relates to technologies for efficiently developing applications used in an information processing apparatus including hardware resources, applications for providing user services that uses the hardware resources, and control services. More particularly, the present invention relates to technologies for efficiently developing applications used in an image forming apparatus by hiding processes for the control services.

2. Description of the Related Art

Recently, an information processing apparatus that includes or connects various hardware resources and that provides user services by using the hardware resources becomes widespread. For example, as an example of the information processing apparatus, an image forming apparatus (to be referred to as a compound machine hereinafter) that includes functions of a printer, a copier, a facsimile, a scanner and the like in a cabinet is generally known. The compound machine includes a display part, a printing part and an image pickup part and the like in a cabinet. In the compound machine, three pieces of software corresponding to the printer, copier and facsimile respectively are provided, so that the compound machine functions as the printer, the copier, the scanner and the facsimile respectively by switching the software.

Since the conventional compound machine is provided with each software for the printer, the copier, the scanner and the facsimile individually, much time is required for developing the software, Therefore, the applicant has developed an image forming apparatus (compound machine) including hardware resources, a plurality of applications, and a platform including various control services provided between the applications and the hardware resources. The hardware resources are used for image forming processes of a display part, a printing part and an image pickup part. The applications perform processes intrinsic for user services of printer, copier and facsimile and the like. The platform includes various control services performing management of hardware resource necessary for at least two applications commonly, execution control of the applications, and image forming processes, when a user service is executed.

Since the image forming apparatus includes the platform that performs management of hardware resources used by at least two applications commonly, and that performs execution control and image forming processes, software can be developed efficiently, so that productivity for the machine can be improved.

According to such a new compound machine, the applications and the control services are provided separately. Thus, after the compound machine is shipped, users or third party venders can develop new applications to install on the compound machine. By doing so, various functions can be provided.

Such a new compound machine has a distinctive feature including applications and control services that provide services required commonly at least two applications. Thus, for developing a new application, it is necessary to write source code for processes of interprocess communication with the control services. However, the processes of interprocess communication should be described as a predefined procedure after accurately grasping functions and messages provided by each control service. Therefore, there is a problem in that it is difficult to describe processes for each control service. This problem is a new problem that was insignificant for a conventional compound machine. In addition, this problem is common to information processing apparatuses having a configuration similar to that of the image forming apparatus.

It is not desirable to disclose all interfaces between each control service and the application to a third party such as a third party vendor that develops a new application from the viewpoint of concealment of information. More particularly, it is desirable to conceal such information that may have a large effect on a system of the compound machine, so that it can be avoided to directly access the control services, from the viewpoint of security of the compound machine and preventing failure from occurring.

### SUMMARY OF THE INVENTION

An object of the present invention is to improve development efficiency of a new application and to conceal important interfaces by hiding complicated processes between an application and control services in an image forming apparatus or an information processing apparatus on which many processes are executed.

The above object can be achieved by a method for generating a new application used in an image forming apparatus is provided, wherein the image forming apparatus includes hardware resources used for image formation, an application for performing processes on image formation, and a control service that exists between the application and the hardware resources, and the method includes; a compile step of compiling a source file of the new application in which source code for calling a wrapping function is described so as to generate an object file, wherein the wrapping function performs processes relating to the control service on behalf of the new application; and a link step of linking the object file with a wrapping function library that includes the wrapping function so as to generate an executable program of the new application.

The above object is also achieved by a method for generating a new application used in an information processing apparatus, the information processing apparatus comprising hardware resources, an application for providing a user service by using the hardware resources, and a control service that exists between the application and the hardware resources, the method including: a compile step of compiling a source file of the new application in which source code for calling a wrapping function is described so as to generate an object file, wherein the wrapping function performs processes relating to the control service on behalf of the new application; and a link step of linking the object file with a wrapping function library that includes the wrapping function so as to generate an executable program of the new application.

According to this method, since the wrapping function performs processes with the control service on behalf of the new application, interfaces to the control service can be hidden, and important interfaces can be concealed. Thus, a new application can be developed efficiently.

### BRIEF DESCRIPTION OF THE DRAWINGS

Other objects, features and advantages of the present invention will become more apparent from the following detailed description when read in conjunction with the accompanying drawings, in which:

FIG. 1 shows a block diagram showing a software configuration of the development server according to the first embodiment of the present invention;

FIG. 2 is a block diagram showing a hardware configuration of a development server and a development PC, and a development environment according to the first embodiment of the present invention;

FIG. 3 is a block diagram showing a functional configuration of the compound machine according to the first embodiment of the present invention;

FIG. 4 shows a hardware configuration of the compound machine according to the first embodiment of the present invention;

FIG. 5 shows a software configuration of an information processing apparatus;

FIG. 6 shows the inside of the process of the new application 317 generated by using the application development kit 131 of the first embodiment, and relationship between the process of the new application 317 and control services such as ECS 324 and MCS 325;

FIG. 7 shows C language source code that is executed in the main thread 501 of the new application generated by using the application development kit of the first embodiment;

FIG. 8 shows a flowchart showing a procedure for receiving an event that is executed by the interprocess communication thread 503 of the new application generated by using the application development kit of the first embodiment of the present invention;

FIG. 9 is a flowchart showing a procedure of a wrapping process performed by the wrapping thread 502 of the new application generated by using the application development kit of the first embodiment of the present invention;

FIG. 10 is a table showing, for each control service, function performed by wrapping, function disclosed to the user without wrapping, and function that is not disclosed to the user at all in the compound machine of the first embodiment of the present invention;

FIG. 11 shows a configuration when VAS is executed;

FIG. 12 shows a flowchart showing a procedure for generating a new application by the development server 100 according to the first embodiment of the present invention;

FIG. 13 shows a file stored in the HD 130 of the development server 100 of the second embodiment of the present invention;

FIG. 14 shows a flowchart showing a procedure for generating the new application by the development server 100 according to the second embodiment of the present invention;

FIG. 15 is a block diagram showing relationships among the new application 317 developed by using the application development kit, the existing application 330, and the control services in the compound machine 317 according to the second embodiment of the present invention;

FIG. 16 shows a configuration of the new application 317 in the case when processes on images such as copying, scanning, printing and the like are executed as threads.

### DETAILED DESCRIPTION OF THE PREFERRED EMBODIMENTS

In the following, preferred embodiments of the present invention will be described with reference to figures. In the following embodiments, an image forming apparatus is taken as an example of the information processing apparatus.

(First Embodiment)

According to the first embodiment, for developing a new application that runs on a compound machines an application source file is prepared by using a development PC (personal computer). Then, an application development kit is installed in a development server, wherein the application development kit is provided by a recording medium such as a CD-ROM. The application source file is compiled and liked, so that an executable file of the application that is executable on the compound machine is generated.

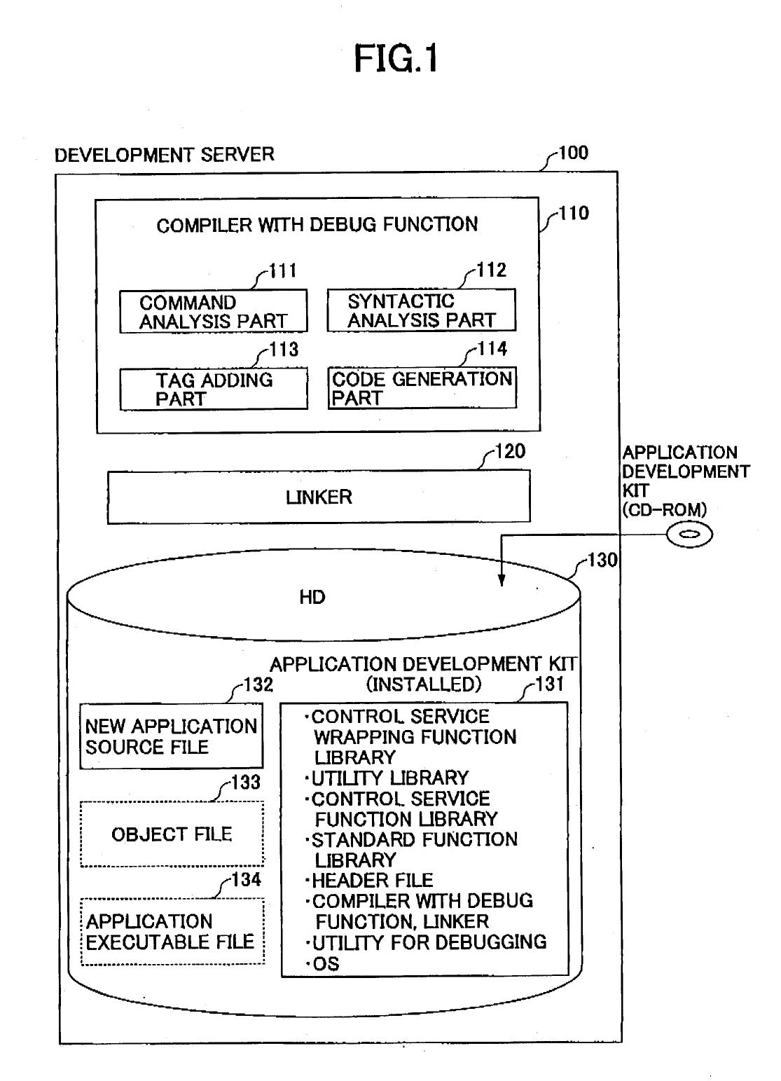

FIG. 1 shows a block diagram showing a software configuration of the development server 100 according to the first embodiment of the present invention. FIG. 1 shows a state in which the application development kit is installed on a hard disk (HD) 130 of the application development kit. The development server 100 of the first embodiment compiles and links the new application source file 132 to generate an executable program 134 to be executed on the compound machine. As shown in FIG. 1, the development server 100 includes a compiler 110 with debugging function and a linker 120.

The compiler 110 with debugging function generates an object file including object codes from a new application source file according to instructions of commands, wherein the new application file 132 is stored in the hard disk (HD) 130 and includes source code of the application. As shown in FIG. 1, the compiler 110 with debugging function includes a command analysis part 111, a syntactic analysis part 112, a tag adding part 113, and a code generation part 114.

The application development kit 131 is installed on the HD 130. In addition, the HD 130 stores a new application source file 132 in which C language source code of the application is described, The new application source file 132 is prepared on the development PC by using an editor, and is copied to the development server 100. In addition, in the HD 130, the object file 133 is generated by the compiler 110 with debugging function, and the application executable file 134 is generated by the linker 120.

The command analysis part 111 analyzes parameters and syntax of a command input from an input device such as a keyboard by a user so as to determine whether the command is grammatical.

The syntax analysis part 112 receives the new application source file 132, analyzes the C language source code of the new application source file 132 according to the C language grammar, so as to generate a derivation tree or a syntactic tree. The syntax analysis part 112 performs the same process as that of a general compiler.

The tag adding part 113 adds tags, which are verifying codes for debugging, to an entrance and an exit of a function in the new application source file 132. The code generation part 114 generate the object file 133 from the new application source file 132 in which syntax analysis is performed and the verification codes are added as necessary. The linker 120 links the object file 133 with a control service function library and a standard function library in the application development kit 131 so as to generate the application executable file 134 that is executable on the compound machine 300 and on an OS of a computer.

The application development kit 131 is provided by a recording medium such as a CD-ROM or a flexible disk (FD). The application development kit 131 can be installed to a computer from the recording medium. The application development kit 131 is installed on the HD 130 of the development server 100. As shown in FIG. 1, the application development kit 131 includes a control service function library for each control service (for example, ECS function library, MCS function library) in which service functions are registered, a standard function library including C language standard functions such as strcpy and memcpy, a control service wrapping function library registering a control service wrapping function wrapping_thrd, a utility library including AplReg function for application registration, and sendmail function and rcvmail function used for inter-thread communication, a header file including function declarations and message declarations commonly used for applications and control services, the compiler 110, the linker 120, a general OS program and utilities for debugging such as a debugger.

The control service wrapping function library registers a control service wrapping function wrapping_thrd. The control service wrapping function wrapping_thrd is used for performing interprocess communication between the application and the control service on behalf of the application. The control service wrapping function wrapping_thrd performs complicated function calls using API and message sending/receiving on behalf of the application 330. Detailed processes of the control service wrapping function wrapping_thrd will be described later.

When the application development kit 131 is launched, each part of the compiler 110 with debugging function and the linker 120 are loaded on a RAM and are executed. Although the application development kit is provided by the recording medium, the executable file or a file that can be installed can be downloaded via the network.

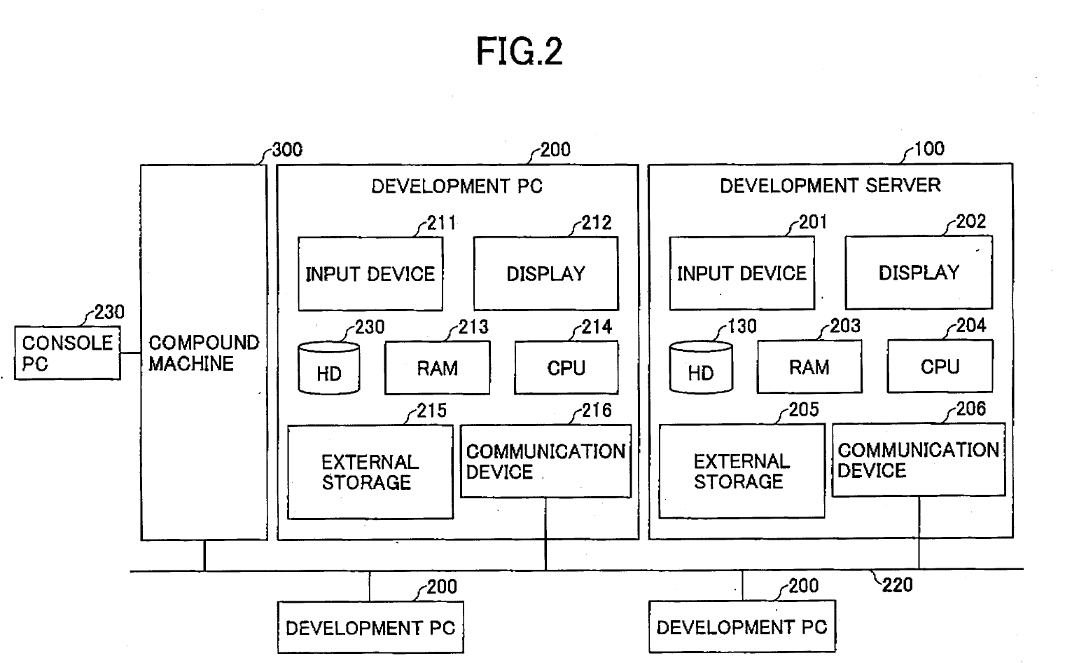

FIG. 2 is a block diagram showing a hardware configuration of the development server and the development PC, and development environment. As shown in FIG. 2, the development server 100 includes a control device 204 such as CPU, a RAM (Random Access Memory) 203, a HD 130, a display 202, an input device 201 such as keyboard and mouse, a communication device 206 such a LAN board and modem, and an external storing device 205 such as flashcard interface for controlling read and write of flashcard and CD drive device for reading CD-ROM. The development server is a normal computer such as a PC and a workstation.

The development server 100 is connected to the development PC 200 and the compound machine 300 via a network such as Ethernet 220, in which a LAN environment is formed. As shown in FIG. 2, the hardware configuration of the development PC 200 is the same as that of the development server 100. A console PC 230 is connected to the compound machine 300 by cables for controlling launch of the compound machine and for displaying error.

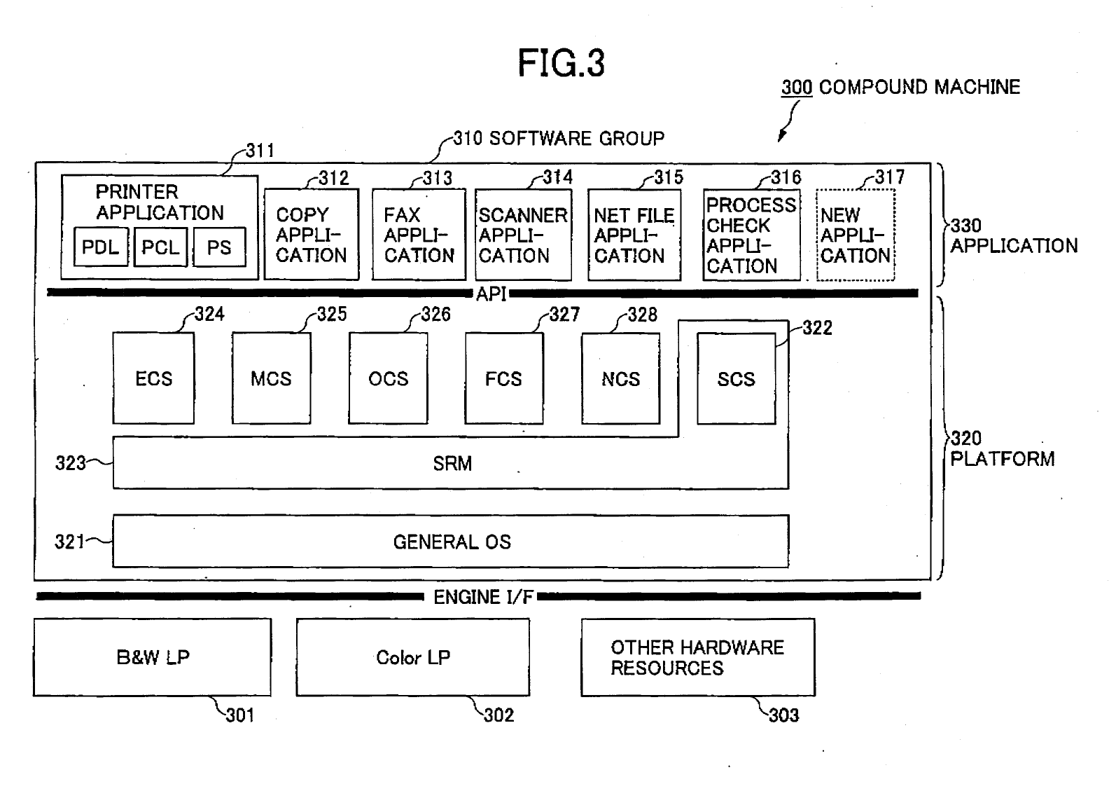

Next, the compound machine 300 to be debugged will be described. FIG. 3 is a block diagram showing a functional configuration of the compound machine. As shown in FIG. 3, the compound machine 300 includes hardware resources and a software group 310. The hardware resources include a black and white line printer (B&W LP) 301, a color line printer 302, and a scanner, a facsimile, a hard disk and a network interface and the like. The software group 310 includes a platform 320 and applications 330.

The platform 320 includes control services for interpreting a processing request from an application so as to issue an acquiring request for hardware resources, a system resource manager (SRM) 323 for managing one or more hardware resources and arbitrating acquiring requests from the control services, and a general-purpose OS 321.

The control services include a plurality of service modules including a system control service (SCS) 322, an engine control service (ECS) 324, a memory control service (MCS) 325, a fax control service (FCS) 327, and a network control service (NCS) 328. In addition, the platform 320 has application program interfaces (API) that can receive process requests from the applications 330 by using predetermined functions.

The general purpose OS 321 is a general purpose operating system such as UNIX, and can execute each piece of software of the platform 320 and the applications 330 concurrently as processes.

The process of the SRM 323 is for performing control of the system and performing management of resources with the SCS 322. The process of the SRM 323 performs arbitration and execution control for requests from the upper layer that uses hardware resources including engines such as the scanner part and the printer part, a memory, a HDD file, a host I/Os (Centronics I/F, network I/F IEEE1394 I/F, RS232C I/F and the like).

Specifically, the SRM 323 determines whether the requested hardware resource is available (whether it is not used by another request). when the requested hardware resource is available, the SRM 323 notifies the upper layer that the requested hardware resource is available. In addition, the SRM 323 performs scheduling for using hardware resources for the requests from the upper layer, and directly performs processes corresponding to the requests (for example, paper transfer and image forming by a printer engine, allocating memory area, file generation and the like).

The process of the SCS 322 performs application management, control of the operation part, display of system screen, LED display, resource management, and interrupt application control. The process of the ECS 324 controls hardware resources including the white and black line printer (B&W LP) 301, the color line printer (Color LP) 302, the scanner, and the facsimile. The process of the MCS 325 obtains and releases an area of the image memory, uses the hard disk apparatus (HDD), and compresses and expands image data.

The process of the FCS 327 provides APIs for sending and receiving of a facsimile from each application layer of the system controller by using a PSTN/ISDN network, for registering/referring of various kinds of facsimile data managed by BKM (backup SRAM) for facsimile reading, for facsimile receiving and printing, and for mixed sending and receiving.

The NCS 328 is a process for providing services commonly used for applications that need the network I/O. The NCS 328 distributes data received from the network by each protocol to a corresponding application, and acts as mediation between the application and the network when sending data to the network. Specifically, the process of the NCS 328 includes server daemons such as ftpd, httpd, lpd, snmpd, telnetd, and smtpd. In addition, the process of the NCS 328 includes client functions of the protocols.

The OCS 326 controls an operation panel that is a means for transferring information between the operator (user) and control parts of the machine. In the compound machine 300 of the embodiment, the OCS 326 includes an OCS process part and an OCS function library part. The OCS process part obtains an key event, which indicates that the key is pushed, from the operation panel 410, and sends a key event function corresponding to the key event to the SCS 322. The OCS function library registers drawing functions and other functions for controlling the operation panel, in which the drawing functions are used for outputting various images on the operation panel on the basis of a request from an application 330 that has control right or from the control service. When the application 330 is developed, functions in the OCS function library is linked to an object program that is generated by compiling a source code file of the application 330, so that an executable file of the application 330 is generated.

Although the OCS 326 is formed by the part executed by a process and the OCS function library in the compound machine 300 of the embodiment, the OCS 326 can be configured such that the whole of the OCS 326 operates as a process, or such that the whole of the OCS 126 is formed by the OCS function library.

The application 330 includes a printer application 311 that is an application for a printer having page description language (PDL) and PCL and post script (PS), a copy application 312, a fax application 313 that is an application for facsimile, a scanner application 314 that is an application for a scanner, a network file application 315 and a process check application 316. Each of the applications 330 is launches as a process by an initializing part (not shown in the figure) when the compound machine 300 is launched.

Interprocess communication is performed between a process of the application 330 and a process of the control service, in which a function is called, a returned value is sent, and a message is sent and received. By using the interprocess communication, user services for image forming processes such as copying, printing, scanning, and sending facsimile are realized.

As mentioned above, the compound machine 300 of the first embodiment includes a plurality of applications 330 and a plurality of control services, and each of those operates as a process. In each process, one or more threads are generated and the threads are executed in parallel. The control services provide common services to the applications 330 User services on image formation such as copying, printing, scanning and sending facsimile are provided while the processes are executed in parallel, the threads are executed in parallel, and interprocess communication is performed- A third party vendor can develop an application (new application 317) for the compound machine 300, and can executes the application in an application layer on the control service layer in the compound machine 300.

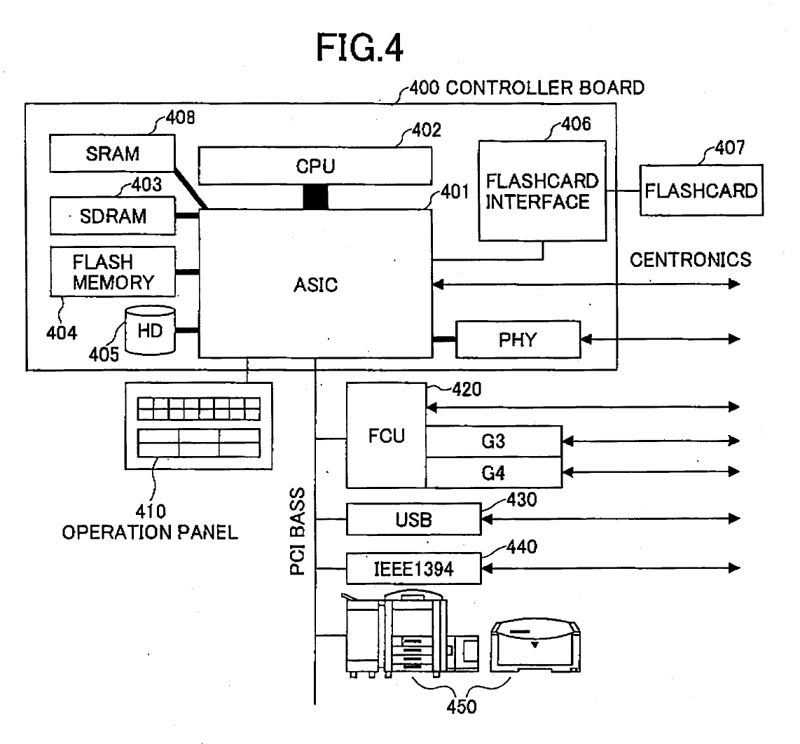

FIG. 4 shows a hardware configuration of the compound machine 300 according to the first embodiment. As shown in FIG. 4, the compound machine 300 includes a controller board 400, an operation panel 410, a fax control unit (FCU) 420, a USB 430, an IEEE1394 440, and a printer 450 and the like. The controller board 400 includes a CPU 402, a SDRAM 403, a SRAM 408, a flash memory (flash ROM) 404, a flash card interface part 406 and a HD 405 that are connected to the ASIC 401. The operation panel 410 is directly connected to the ASIC 401. The FCU 420, the USB 430, the IEEE1394 440 and the printer 450 are connected to the ASIC 401 via the PCI bus.

A flashcard 407 is inserted into a flash card interface part 406, so that data is sent/received between the compound machine 300 and the flashcard 407 via the flash card interface part 406. The flashcard 407 stores billing information of the user and the like.

The operation panel 410 includes an operation part used for key operation such as key input and button pushing and the like by the user, and an display part for displaying drawing data such as a button, a window and various screens.

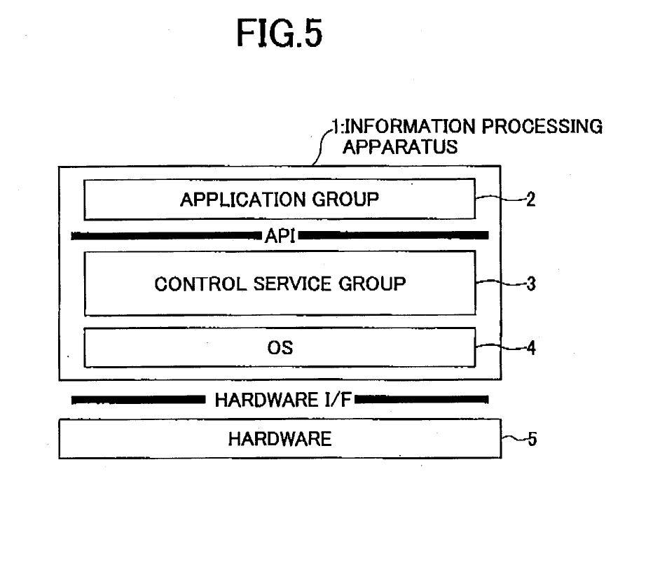

It is easy to replace the printer part 450 with other hardware in the image forming apparatus in FIG. 4. By replacing the printer part 450 with other hardware, the structure of FIG. 4 becomes an example of a general information processing apparatus that provides user services by using the hardware. In this case, in the software configuration of FIG. 3, control services and applications are used according to functions of the hardware. An example of a software configuration of the information processing apparatus is shown in FIG. 5. In the same way as the configuration of FIG. 3, the configuration of FIG. 5 includes an application group 2, a control service group 3, OS 4, and hardware resources 5.

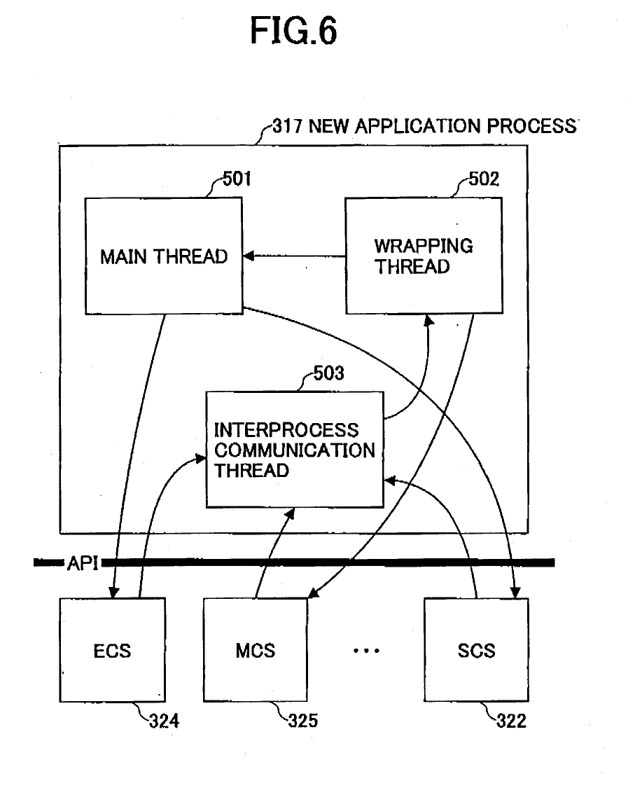

FIG. 6 shows the inside of the process of the new application 317 generated by using the application development kit 131 of the first embodiment. In addition, FIG. 6 shows relationship between the process of the new application 317 and control services such as ECS 324 and MCS 325. As shown in FIG. 6, in the inside of the process of the new application 317, three threads including at least a main thread 501, a wrapping thread 502 and an interprocess communication thread 503 are generated and operated.

The main thread 501 is a thread that controls whole processes of the new application 317. Development of the new application 317 is to prepare a main function “main” that is executed as the main thread 501.

The wrapping thread 502 is a thread that is generated by the main thread 501 by issuing the control service wrapping function wrapping_thrd. The wrapping thread 502 accesses each control service by using API on behalf of the main thread 501, and sends the process result to the main thread 501. More specifically, for example, the thread 502 calls a service function provided by the control service by using the API, and performs interprocess communication such as message sending.

The interprocess communication thread 503 receives an event from each control service, and sends the received event to the wrapping thread 502. That is, the event received by the interprocess communication thread 503 should be sent to the main thread 501. However, according to the first embodiment, the event is sent to the wrapping thread 502 first, and, the wrapping thread 502 sends the received. event to the main thread 501, or, the wrapping thread 502 carries out response processes for the received event on behalf of the main thread 501, without sending the received event to the main thread 501.

Communication between threads is performed via a mail box. When a thread issues a sendmail function by specifying a mail box, data is stored in the specified mailbox. Another thread can obtain data stored in the specified mail box by issuing a rcvmail function by specifying the mail box specified by the sendmail function.

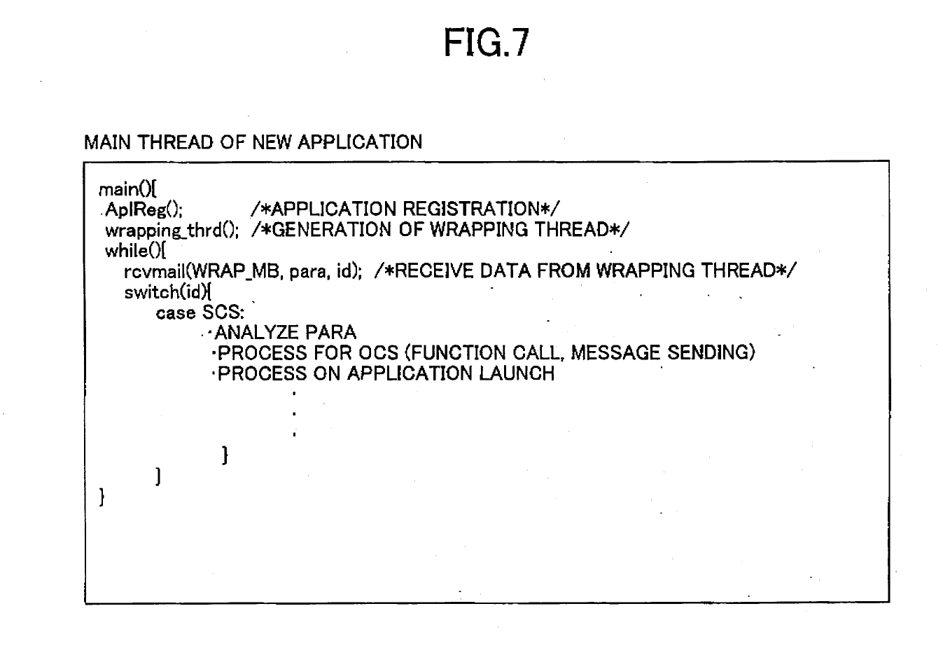

FIG. 7 shows a C language source code that is processed in the main thread 501. FIG. 7 shows an example, and source code for the main thread 501 is not limited to that shown in FIG. 7. The source code can be determined according to the function of the new application 317 to be developed. In addition, the language is not limited to C language, and other language can be used.

In the main thread 501, following processes are performed. In other words, a user develops the new application 317 by writing the code of the main function of the new application 317 such that following processes are performed. First, as shown in FIG. 7, the wrapping thread 502 is generated by wrapping_thrd. the function wrapping_thrd is registered in the control service wrapping function library.

Next, as actual processes of the application, following processes are described. In a “while” loop, data is obtained from the wrapping thread 502 via the mail box WRAP_MB by using the rcvmail function. The argument id indicates an identifier (for example, process ID and the like) of the control service that sent the received data. After that, processes are described for each control service such as SCS 322. In the example shown in FIG. 7, when id is SCS 322, analysis of para, processes for OCS 326 using APT such as function call, message sending and the like on the basis of the analysis, processes for application launching are described on the basis of the desired function of the new application 317. After exiting while loop, end of the application is notified of to the compound machine 300, so that the resource is released.

In the example of FIG. 7, in the while loop, processes for OCS 326 and processes on application launching are described. However, processes for other control services such as ECS 324, MCS 325 and the like by using API are not described. The reason of this is that API processes for the control services are performed by after-mentioned wrapping threads since the API processes for the control services are complex.

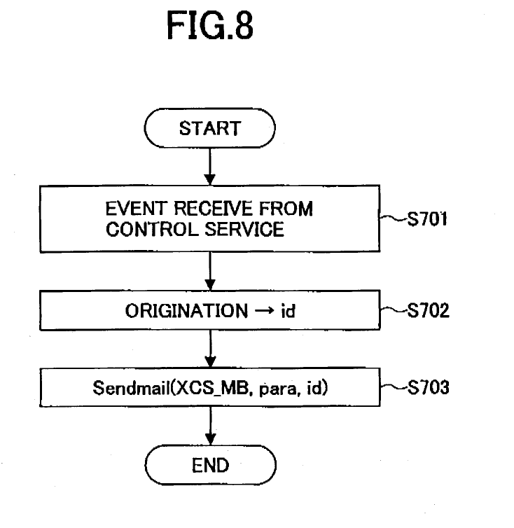

FIG. 8 shows a flowchart showing a procedure for receiving the event that is executed by the interprocess communication thread 503. The interprocess communication thread 503 waits for an event from the control service. When the interprocess communication thread 503 receives the event in step S701, the identifier of the control service that issues the event is set to “id” in step S702. Then, the interprocess communication thread 503 sends the received event to the wrapping thread 502 via the mail box XCS_MB by using the sendmail function in step S703. More specifically, each control service has functions such as Res_ecs( ), Res_mcs( ), RESC_scs( ) and the like. In each function, the sendmail function in which an identifier of a control service that sent the event is set to “id” is issued.

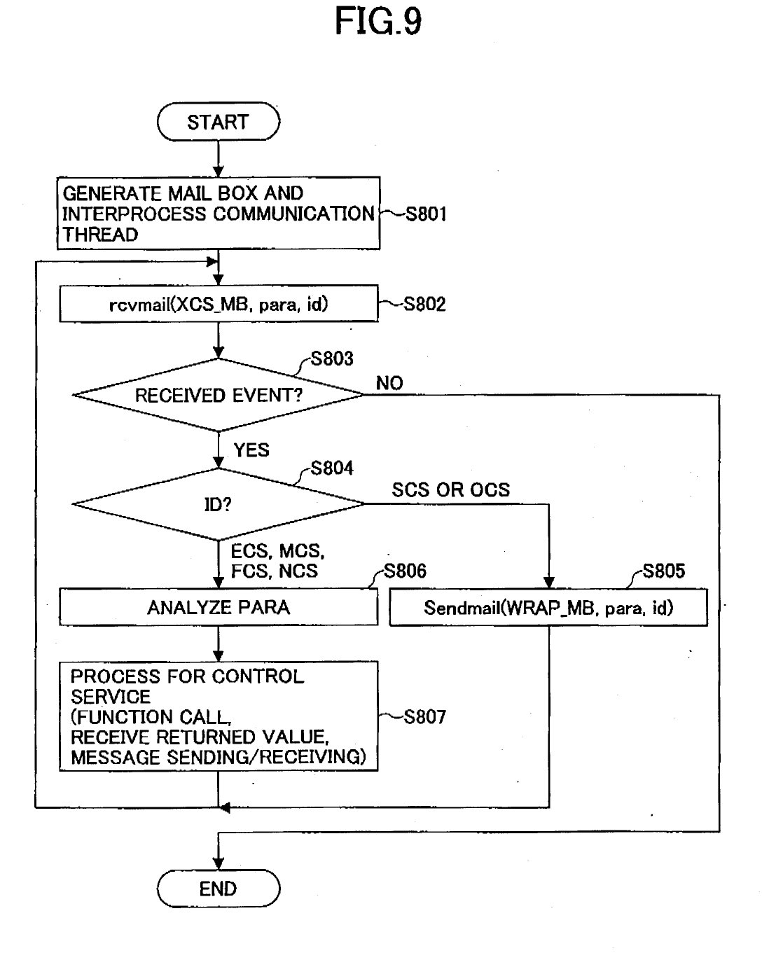

FIG. 9 is a flowchart showing a procedure of the wrapping process performed by the wrapping thread 502 (wrapping_thrd function). First, the wrapping thread 502 generates the interprocess communication thread 503, and generates the mail boxes WRAP_MB and XCS_MB used for communication between threads in step S801. Then, rcvmail (XCS_MB, para, id) function is issued in step S802, so that the wrapping thread 502 checks whether the event of the control service received from the interprocess communication thread 503 exists in the mail box XCS_MB in step S803.

If the received event does not exist in the mailbox XCS_MB, the process ends, and the wrapping thread 502 enters in a sleeping state. If the received event exists in the mail box XCS_MB, the control service that originates the event can be determined from a value set in the argument id in step 8804.

From the “id”, if the control service that originates the event is SCS 322 or OCS 326, an identifier of SCS or OCS is set to “id”, and sendmail (WRAP_MB, para, id) function is issued, so that the received event is sent to the main thread 501 via the mail box WRAP_MB in step S805. Accordingly, in the main thread 501, the received event can be received as it is by the rcvmail (WRAP_MB, para, id).

In step S804, if the control service that originates the event is control services other than SCS 322 or OCS 326, that is, if the control service is ECS 324, MCS 325, FCS 327 or NCS 328, the wrapping thread 502 does not send the received event to the main thread 501 by sendmail function. Instead, the wrapping thread 502 analyses the parameter set in the argument para in step S806. Processing for the control service for the received event (function call and receiving return value by using API, message sending/receiving and the like) is performed in the wrapping thread 501 in step S807. By performing such wrapping processes, it is not necessary to describe complicated processes by using API for the control service in the source code of the main thread 501 that is prepared by the user.

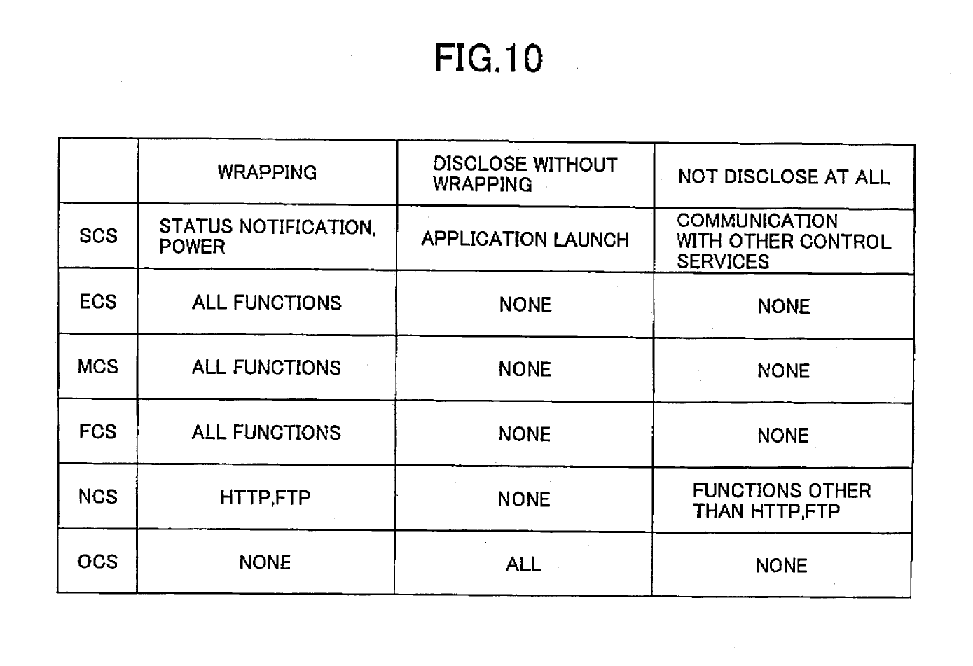

The wrapping process is predetermined for each control service. FIG. 10 is a table showing, for each control service, function performed by wrapping, function disclosed to the user without wrapping, and function that is not disclosed to the user at all. As shown in FIG. 10, when the control service that originates the event is SCS 322, functions on notification of the state of the machine and on the power source such as notification of power off and the like are performed by wrapping by the wrapping thread 502 to avoid an ill effect on the system of the compound machine 300 due to erroneous coding by the user, so that any event on notification of the state of the machine, notification of power off and the like is not sent to the main thread 501.

For example, when the cover of the compound machine 300 is open, the SCS 322 detects this state, and a machine state notification event is sent to the interprocess communication thread 503 of the new application 317. The interprocess communication thread 503 receives this event by using rcvmail function, and sends the event to the wrapping thread 502, not to the main thread 501, by using the sendmail function, In the wrapping thread 502, when the machine state notification event from the SCS 322 is received by the rcvmail function, interprocess communication with OCS 326 is performed so as to display a message notifying of cover open on the operation panel 410 Therefore, it is not necessary to describe any process for interprocess communication accompanied by receiving the machine state notification event in the source code of the main thread 501 prepared by the user. For the power off notification event, the same processes are performed in the wrapping thread 502.

However, as shown in FIG. 10, since wrapping is not performed for functions on launch of application, an event on the launch of application is sent to the main thread 501 from the wrapping thread 502 by the sendmail function. Further, interprocess communication between the SCS 322 and other control services is not disclosed to the user.

As shown in FIG. 10, if the control service that originates the event is ECS 324, MCS 325 or FCS 327, wrapping is performed by the wrapping thread 502 for every service Thus, any event from the ECS 324 and the MCS 324 is not sent to the main thread 501. For example, if the received event is sent from the ECS 324, API function call such as memory reserving request for MCS 325, resource acquiring request for the SRM 323 and the like, and message sending/receiving on the requests are performed in the wrapping thread 502. If the origination source of the received event is the MCS 325, for example, function call such as resource acquiring request for the SRM 323 and message sending/receiving on the request are performed in the wrapping thread 502. Further, if the origination source of the received event is FCS 327, for example, function call such as job mode setting request to ECS 324, job start request, and job close request, and message receiving such as job end notification are performed in the wrapping thread 502.

As shown in FIG. 10, if the control service that originates the event is NCS 328, the wrapping thread 502 performs processes on data sending protocol. For example, processes on each protocol such as http and ftp are performed in the wrapping thread 502. If the control service is the NCS 328, processes other than the process on the data sending protocol is not open, and are not performed in the main thread 501.

As shown on FIG. 10, if the control service that originates the event is OCS 326, all functions are open to the user, and wrapping is not performed. Thus, every event from the OCS 326 is sent to the main thread 501 by the sendmail function.

According to the wrapping function of the application development kit 131 according to the first embodiment, functions to be performed by wrapping are determined for each control service. The functions to be performed by wrapping are not limited to the above-mentioned example, and other functions can be performed by wrapping.

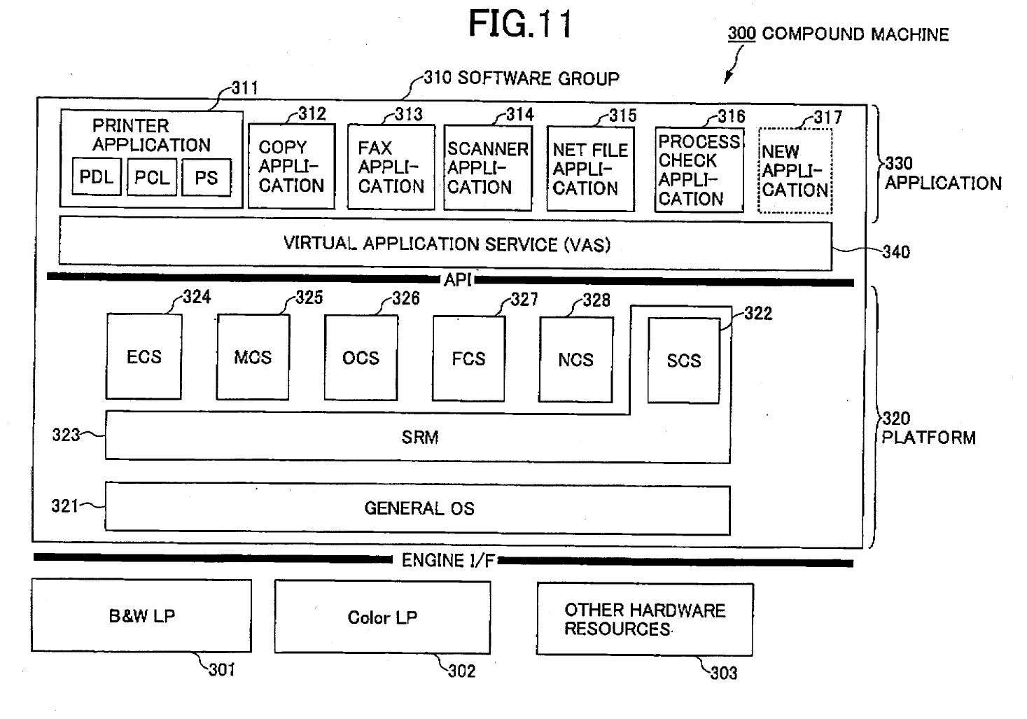

As an example of the other functions, there is a virtual application service (to be referred to as VAS hereinafter). FIG. 11 shows a configuration when VAS is executed. As shown in FIG. 11, VAS 340 exists between the application 330 and the platform 320.

According to the VAS 340, when the version of a control service or the API is updated due to change of specification and the like, function call can be performed by the application without compiling the application again. That is, the VAS 340 has functions for absorbing difference of versions and keeping consistency, and for hiding the platform 320 by choosing messages from the control service. In addition, when an application is registered, the VAS 340 detects each version of the application, the control service and the API. Then, the VAS 340 determines whether difference of the versions is within a range that can be supported by the VAS 340. The determination result is sent to the application. That is, the VAS has functions of version management to determine whether the versions are consist before using the application.

Since the VAS 340 is regarded as a control service from the viewpoint of the application, wrapping for processes on VAS 340 can be performed in the same way as wrapping for the control services described so far.

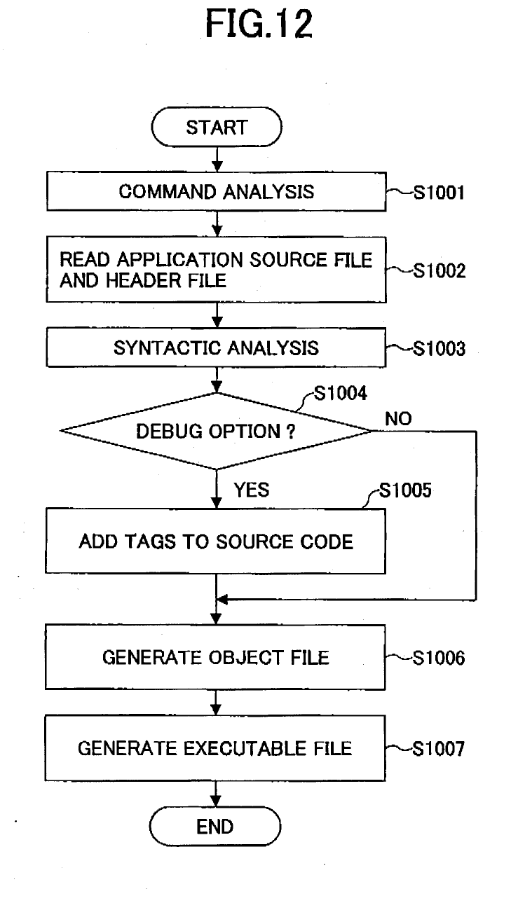

In the following, a procedure for generating the new application 317 by using such wrapping function will be described. FIG. 12 shows a flowchart showing a procedure for generating a new application by the development server 100. When a launching command is input, the compiler 110 with debugging function is launched, and the command analysis part 111 in the compiler 110 analyzes the input command in step S1001. More specifically, the command analysis part 111 analyzes parameters and syntax so as to determine whether the input command is grammatical.

Next, the syntax analysis part 112 reads the new application source file 132 and the header file in the installed application development kit 131 in step S1002. Then, the syntax analysis part 112 performs syntactic analysis of C language source code in the new application source file 132 in step S1003. More specifically, the syntax analysis part 112 analyses the C language source code according to C language grammar to generate a derivation tree and a syntax tree and the like.

Then, the command analysis part 111 checks whether a debug option is set in the input launch command in step $1004. If the debug option is set, tags as verification code are added, for example, at the entrance and at the exit of an function, in step S1005. The tag is used for debugging printf clause, assert clause and the like, such that a variable, an argument of a function and a return value of a function are output. If the debug option is not specified, the process for adding the tag is not performed, and a normal compile process is performed.

Next, the code generation part 114 performs a code generation process so as to generate object code of the new application, and stores the object code in the HD 130 as the object file 133 in step S1006. Then, the object file 133 is linked with the control service function library, the standard function library, wrapping function library, and utility library of the application development kit 131, so that the application executable file 134 is generated in step S1007. Accordingly, the new application 317 is generated.

As mentioned above, according to the application generation method using the application development kit of the first embodiment, the user can develop a new application efficiently only by grasping outlines of functions of each control service. That is, by using the control service wrapping function library, it is not necessary to describe code of complicated procedures for interprocess communication with control services.

In addition, according to the application generation method using the application development kit of the first embodiment, the wrapping function performs interprocess communication with control services on behalf of the new application 317. Therefore, interfaces between control services and an application can be hidden, so that important interfaces can be concealed.

The wrapping function is not necessarily performed as a thread as long as the rapping function describes processes for the control service.

(Second Embodiment)

In the application generation method of the first embodiment, the new application 317 is generated by using the control service wrapping function library in the application development kit 131, so that the wrapping thread 502 in the process of the new application 317 hides processes for the control services. In the application generation method of the second embodiment, the new application 317 is generated by using an application wrapping function in the application development kit 131, so that processes for control services are hidden by using existing applications.

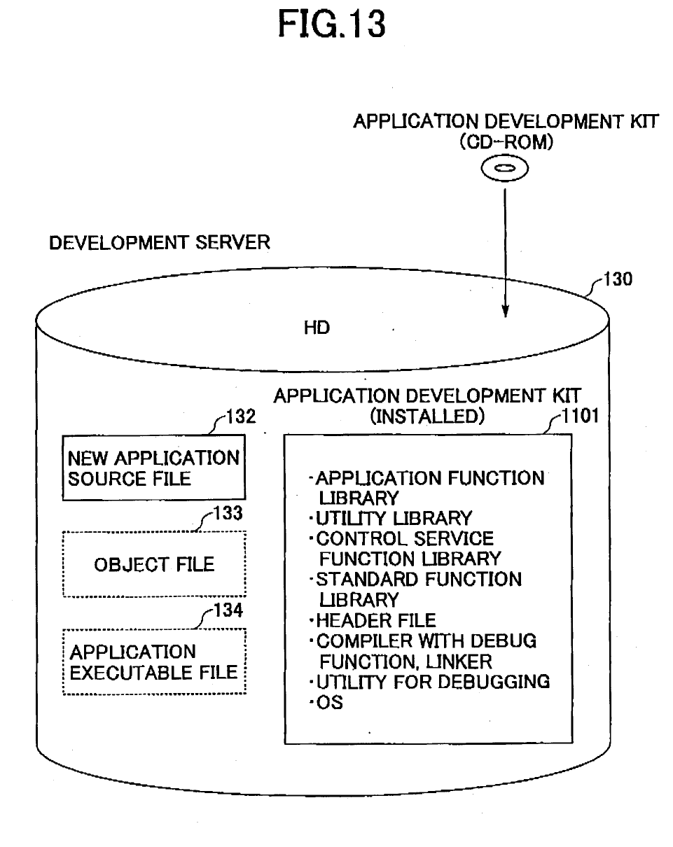

FIG. 13 shows a file stored in the HD 130 of the development server 100 of the second embodiment. In the HD 130, like the development server of the first embodiment, the application development kit 1101 is installed, and the new application source file 132, the object file 133, and the application executable file 134 are generated. The application development kit 1101 is provided by a recording medium such as a CD-ROM and a flexible disk.(FD), and the application development kit 1101 can be installed to a computer. As shown in FIG. 13, the application development kit 1101 includes a control service function library, a standard function library, an application function library, a utility library, a header file, a compiler with debugging function, a linker, a general OS program, and a utility for debugging. The control service function library, the standard function library, the utility library, the header file, the compiler with debugging function, the liner, the general OS program, and the utility for debugging are the same as those included in the application development kit 131 in the first embodiment. That is, the application development kit 1101 of the second embodiment differs from the application development kit 131 of the first embodiment in that it includes the application (wrapping) function library.

The application function library includes a printer function printap( ) for calling the printer application 311, a scanner function scanap( ) for calling scanner application 314, a copy function copyap( ) for calling the copy application 312, a fax send function faxap_send ( ) and a fax receive function faxap_rcv ( ) for calling the fax application 313.

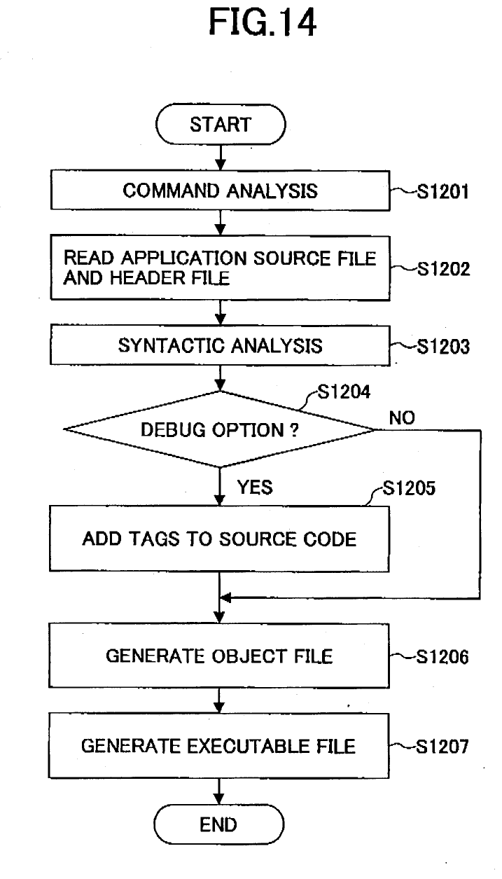

Next, the generation process of the new application 317 by using the application function library will be described. FIG. 14 shows a flowchart showing the procedure for generating the new application by the development server 100. Processes from analysis of launching command to generation of the object file 133 (steps S1201-S1206) are the same as those of steps S1001-S1006 shown in FIG. 12.

After the object file 133 of the new application 317 is generated, the object file 133 is linked with the control service function library, the standard function library, the application function library, and the utility library, so that the application executable file 134 is generated in step S1207. Accordingly, the new application 317 is generated.

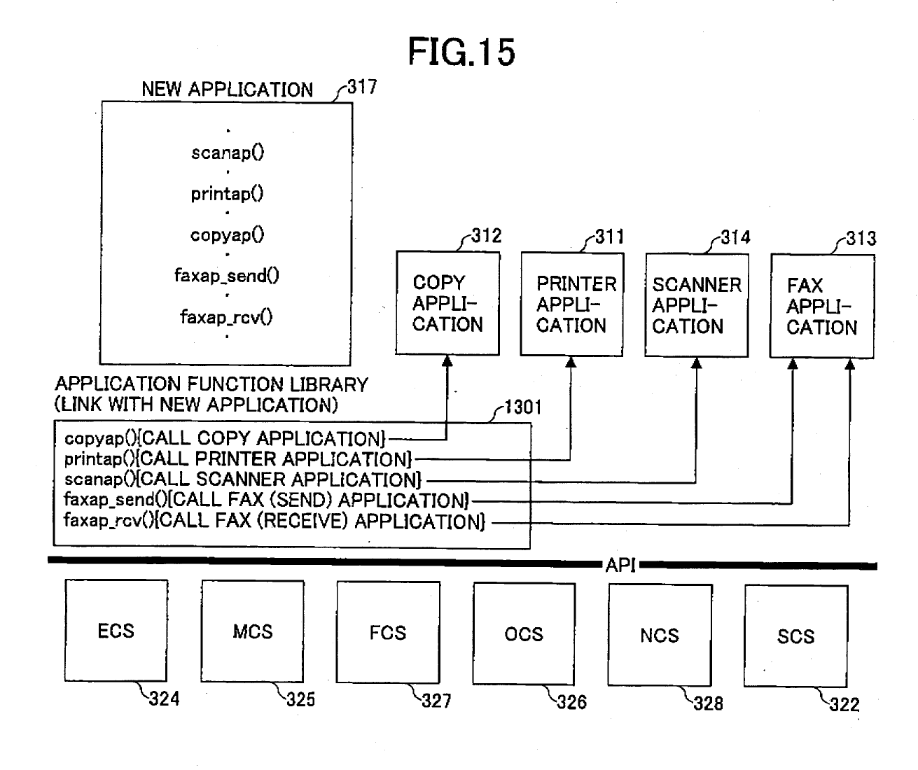

FIG. 15 is a block diagram showing relationships among the new application 317 developed by linked with the application function library 1301, the existing application 330, and the control services in the compound machine 317. As shown in FIG. 15, the source code of the new application 317 includes a scanner function scanap for using scanner function, a printer function printap for using printing function, a copy function copyap for using copy function, a fax send function faxap_send for using fax sending function, and a fax receive function faxap_rcv for using fax receiving function.

These functions are registered in the application function library 1301, and the application function library 1301 is linked to the new application 317. Thus, the scanner application 314 is called by scanap function call, the printer application 311 is called by printap function call, the copy application 312 is called by copyap function call, and the fax application 313 is called by faxap_send function call and faxap_rcv function call.

In each application, calling of service functions of complicated procedure is performed, or interprocess communication by message sending/receiving is performed for processes of control services such as ECS 324 and MCS 325. Therefore, it is not necessary to write the procedure of the interprocess communication in the source code of the new application 317. A function in the application library 1301 can be called according to each function.

That is, for example, if the application wrapping is not performed, when using scanner function, an error may arise in the description of the interprocess communication for a control service even through API is provided, since each process for the control service should be described, such as job generation request and job mode setting request for the ECS 324, and memory keeping request for the MCS 325. On the other hand, according to the new application 317 generated by the application generation method of the second embodiment, by calling a function registered in the application function library 1301, an application corresponding to each function is called, so that interprocess communication between the called application and the control service is realized. Thus, wrapping in the new application for control services is realized and development of the new application 317 can be performed efficiently.

In the second embodiment, although calling of existing application from the new application 317 is performed in the compound machine 300, the calling may be performed via a network. For example, in compound machines connected by a network, a new application in a compound machine calls an application in another compound machine. In addition, a hard disk of a computer connected to a compound machine via a network for performing debugging stores the new application 317, and the hard disk is mounted on the compound machine 300 by NPS (network file system), so that the new application 317 in the computer can call the existing application in the compound machine 300 via a network. The calling of the application via the network can be realized by using RPC (remote procedure call) and the like.

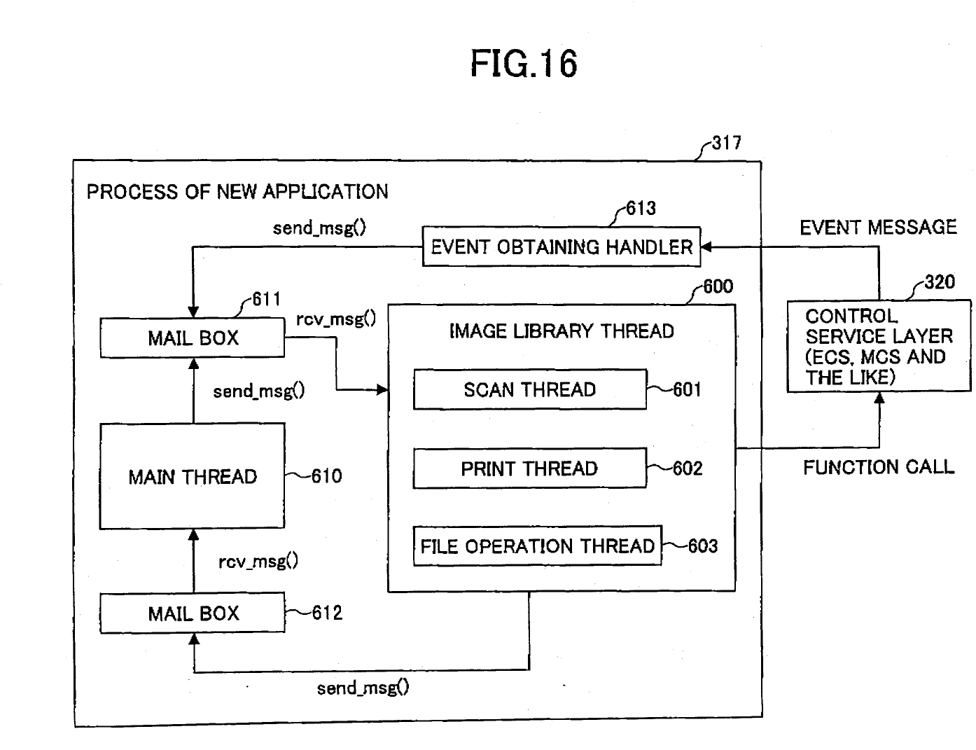

The new application 317 can be configured such that processes on an image such as copying, scanning, printing and the like are executed as threads. In this case, an image library is linked with the new application 317, in which the image library includes functions describing processes on image. FIG. 16 shows a configuration of the new application 317 when it is executed.

As shown in FIG. 16, a multithread environment is generated in the process of the new application in which a plurality of threads are executed in parallel. That is, a main thread 610 and an image library thread 600 are executed in parallel. The main thread 610 is a thread for executing processes of the new application (character recognition process, for example). The main thread 610 uses the image library.

The image library thread 600 provides each function of the image library, and is executed by the main thread 610. At this time, in the image library thread 600, a plurality of sub-threads corresponding to libraries in the image library are launched. That is, a scan thread 601, a print thread 602 and file operation thread 603 are launched. In addition, in the process of the new application, a mail box 611, a mail box 612, and an event obtaining handler (thread) 613 are launched.

The mail box 611 is used for communication among the main thread 610, the image library thread 600 and the event obtaining handler 613. The mail box 612 is used for communication between the main thread 610 and the image library thread 600. The event obtaining handler 613 receives an event message prom a process of the control service such as ECS 324 and MCS 325, and writes the event message in the mail box 611.

The main thread 610 passes a function call command for the image library thread 600 to the mail box 611. An event message from the control service 320 is also put in the mail box 611. The image library thread 600 obtains a message in the mail box 611 by using a rcv_msg function. Then, necessary processes are performed while a sub_thread performs interprocess communication with the control service on the basis of the message.

The image library thread 600 sends, to the mail box 612, notification for the main threads such as error information, execution result, progress and the like. The main thread 610 obtains the message delivered to the mail box 612 by using the rcv_msg ( ), and performs processes corresponding to information of the message.

Since complicated processes relating to interprocess communication with the control service is performed by the image library thread 600, it is not necessary to describe the complicated processes in the “main” function when developing a new application. That is, wrapping is realized.

In the above-mentioned example, processes of the image library is not necessarily executed as the thread 600. By preparing a library including functions for wrapping, a new application can be developed efficiently by using functions of the library.

According to the present invention, a method for generating a new application used in an image forming apparatus is provided, wherein the image forming apparatus includes hardware resources used for image formation, an application for performing processes on image formation, and a control service that exists between the application and the hardware resources, and the method includes: a compile step of compiling a source file of the new application in which source code for calling a wrapping function is described so as to generate an object file, wherein the wrapping function performs processes relating to the control service on behalf of the new application; and a link step of linking the object file with a wrapping function library that includes the wrapping function so as to generate an executable program of the new application.

According to this method, since the wrapping function performs processes with the control service on behalf of the new application, interfaces to the control service can be hidden, and important interface can be concealed.

In the method, the wrapping function may perform interprocess communication with the control service. In this method, only important part of interfaces can be concealed, and other part can be disclosed to a third party.

In the method, the wrapping function may be executed as a wrapping thread that is generated in a process of the new application. Accordingly, when a process of the interprocess communication with control service on behalf of the new application and other process are executed in parallel, time taken for switching the processes can be decreased.

In addition, the wrapping function performs a response process to an event sent from the control service. Thus, it is not necessary to describe source code for especially complicated procedures of interprocess communication with the control service in which a response is necessary for an event. Thus, the new application can be developed more efficiently.

In the method, the wrapping function may perform interprocess communication for every service provided by an engine control service that performs control of an engine of the image forming apparatus.

According to this method, interfaces to the engine control service can be hidden, in which the engine control service controls the engine part important for the image forming apparatus Thus, especially important interfaces can be concealed, and engine troubles due to programming mistake of the new application can be avoided.

In the method, the wrapping function may perform interprocess communication for every service provided by an memory control service that performs control of a memory of the image forming apparatus.

According to this method, it is not necessary to describe complicated procedures of interprocess communication with the memory control service, so that the new application can be developed efficiently. In addition, interfaces to the memory control service can be hidden, in which the memory control service controls a memory important for the image forming apparatus. Thus, especially important interfaces can be concealed, and memory troubles due to programming mistake of the new application can be avoided.

In the method, the wrapping function may perform interprocess communication for services on system status notification and power source status in services provided by a system control service that performs system control of the image forming apparatus.

According to this method, it is not necessary to describe complicated procedures of interprocess communication for system status notification and power status, so that the new application can be developed efficiently. In addition, interfaces to the system control service on the system status notification and power status can be hidden, in which the system control service on the system status notification and power status is important for operation of the image forming apparatus. Thus, especially important interfaces can be concealed, and troubles due to programming mistake of the new application can be avoided.

In the method, the wrapping function may perform interprocess communication for services that uses a data communication protocol in services provided by a network control service that performs network control of the image forming apparatus.

According to this method, it is not necessary to describe complicated procedures of interprocess communication for data communication protocol, so that the new application can be developed efficiently.

In the method, the wrapping function may perform interprocess communication for services provided by control services except for an operation panel control service that controls an operation panel in the image forming apparatus. Thus, interfaces with the operation panel that is often used by the new application are disclosed to a third party while other complicated interfaces can be hidden.

In the method, the wrapping function may perform interprocess communication for a service provided by a virtual application service that is provided between the application and the control service in the image forming apparatus. According to this method, it is not necessary to describe complicated procedures of interprocess communication for the virtual application service, so that the new application can be developed efficiently.

In addition, a computer program for causing a computer to generate the new application by using the above-mentioned is provided. By executing the program, the executable program of the new application can be obtained. In addition, the executable program of the new application, and computer readable recording medium are provided according to the present invention. Further, an image forming apparatus including the generated executable program can be provided.

In addition, according to the present invention, an application development recording medium used for developing the new application is provided, in which the application development recording medium includes; an application generation program for causing a computer to generate an executable program of the new application from a source file in which source code of the new application is described; and a wrapping function library including a wrapping function that performs processes relating to the control service on behalf of the new application.

According to this medium, it is not necessary to describe complicated procedures of interprocess communication with the control service, so that the new application can be developed efficiently. In addition, since the wrapping function performs processes with the control service on behalf of the new application, interfaces to the control service can be hidden, and important interface can be concealed.

In addition, according to the present invention, a method for generating a new application used in the image forming apparatus is provided, in which the method includes: a compile step of compiling a source file of the new application in which source code for calling an application function is described so as to generate an object file, wherein the application function executes an existing application that performs interprocess communication with the control service on behalf of the new application; and a link step of linking the object file with an application function library that includes the application function so as to generate an executable program of the new application.

According to this method, the existing application performs interprocess communication with the control service on behalf the new application, Thus, it is not necessary to describe complicated procedures of interprocess communication with the control service, so that the new application can be developed efficiently.

In the method, the existing application may be an copy application, a printer application, a fax application, or a scanner application. Accordingly, even when the new application includes a copy function, a printer function, a fax function or a scanner function, interprocess communication between the new application and the control service can be performed via an application corresponding to each function. Thus, it is not necessary to describe complicated procedures of interprocess communication with the control service, so that the new application can be developed efficiently. As for this method, a program for performing this method, an executable program generated by this method, recording mediums, and the image forming apparatus can be provided.

In addition, an application development recording medium used for developing the new application is provided, in which the application development recording medium includes: an application generation program for causing a computer to generate an executable program of the new application from a source file in which source code of the new application is described; and an application function library including an application function that executes an existing application that performs interprocess communication with the control service on behalf of the new application.

According to the present invention, methods, programs and the like can be provided for the information processing apparatus in the same way as the above-mentioned methods and programs for the image forming apparatus.

As mentioned above, according to the present invention, it is not necessary to describe complicated procedures relating to interprocess communication with control service in the source code of the new application, so that the new application can be developed efficiently.

The present invention is not limited to the specifically disclosed embodiments, and variations and modifications may be made without departing from the scope of the present invention.

What is claimed is:

1. A method for generating a new application used in an image forming apparatus, said image forming apparatus comprising hardware resources used for image formation, an application for performing processes on image formation, and a control service that exists between said application and said hardware resources, said method comprising:
a compile step of compiling a source file of said new application in which source code for calling a wrapping function is described so as to generate an object file, wherein said wrapping function performs processes relating to said control service on behalf of said new application; and
a link step of linking said object file with a wrapping function library that includes said wrapping function so as to generate an executable program of said new application.

2. The method as claimed in claim 1, wherein said wrapping function performs interprocess communication with said control service.

3. The method as claimed in claim 1, wherein said wrapping function is executed as a wrapping thread that is generated in a process of said new application.

4. The method as claimed in claim 2, wherein said wrapping function performs a response process to an event sent from said control service.

5. The method as claimed in claim 1, wherein said wrapping function performs interprocess communication for every service provided by an engine control service that performs control of an engine of said image forming apparatus.

6. The method as claimed in claim 1, wherein said wrapping function performs interprocess communication for every service provided by an memory control service that performs control of a memory of said image forming apparatus.

7. The method as claimed in claim 1, wherein said wrapping function performs interprocess communication for services on system status notification and power source status in services provided by a system control service that performs system control of said image forming apparatus.

8. The method as claimed in claim 1, wherein said wrapping function performs interprocess communication for services that uses a data communication protocol in services provided by a network control service that performs network control of said image forming apparatus.

9. The method as claimed in claim 1, wherein said wrapping function performs interprocess communication for services provided by control services except for an operation panel control service that controls an operation panel in said image forming apparatus.

10. The method as claimed in claim 1, wherein said wrapping function performs interprocess communication for a service provided by a virtual application service that is provided between said application and said control service in said image forming apparatus.

11. A computer program for causing a computer to generate a new application used in an image forming apparatus, said image forming apparatus comprising hardware resources used for image formation, an application for performing processes on image formation, and a control service that exists between said application and said hardware resources, said computer program comprising:
a compile program code means for compiling a source file of said new application in which source code for calling a wrapping function is described so as to generate an object file, wherein said wrapping function performs processes relating to said control service on behalf of said new application; and
a link program code means for linking said object file with a wrapping function library that includes said wrapping function so as to generate an executable program of said new application.

12. The computer program as claimed in claim 11, wherein said wrapping function performs interprocess communication with said control service.

13. The computer program as claimed in claim 11, wherein said wrapping function is executed as a wrapping thread that is generated in a process of said new application.

14. A computer program generated by a method for generating a new application used in an image forming apparatus, said image forming apparatus comprising hardware resources used for image formation, an application for performing processes on image formation, and a control service that exists between said application and said hardware resources, said method comprising:
a compile step of compiling a source file of said new application in which source code for calling a wrapping function is described so as to generate an object file, wherein said wrapping function performs processes relating to said control service on behalf of said new application; and
a link step of linking said object file with a wrapping function library that includes said wrapping function so as to generate an executable program of said new application.

15. A computer readable recording medium storing program code for causing a computer to generate a new application used in an image forming apparatus, said image forming apparatus comprising hardware resources used for image formation, an application for performing processes on image formation, and a control service that exists between said application and said hardware resources, said computer readable recording medium comprising:
a compile program code means for compiling a source file of said new application in which source code for calling a wrapping function is described so as to generate an object file, wherein said wrapping function performs processes relating to said control service on behalf of said new application; and
a link program code means for linking said object file with a wrapping function library that includes said wrapping function so as to generate an executable program of said new application.

16. The computer readable recording medium as claimed in claim 15, wherein said wrapping function performs interprocess communication with said control service.

17. The computer readable recording medium as claimed in claim 15, wherein said wrapping function is executed as a wrapping thread that is generated in a process of said new application.

18. A computer readable recording medium storing a computer program generated by a method for generating a new application used in an image forming apparatus, said image forming apparatus comprising hardware resources used for image formation, an application for performing processes on image formation, and a control service that exists between said application and said hardware resources, said method comprising:
a compile step of compiling a source file of said new application in which source code for calling a wrapping function is described so as to generate an object file, wherein said wrapping function performs processes relating to said control service on behalf of said new application; and
a link step of linking said object file with a wrapping function library that includes said wrapping function so as to generate an executable program of said new application.

19. An image forming apparatus that includes a program generated by a method for generating a new application used in said image forming apparatus, said image forming apparatus comprising hardware resources used for image formation, an application for performing processes on image formation, and a control service that exists between said application and said hardware resources, said method comprising:
a compile step of compiling a source file of said new application in which source code for calling a wrapping function is described so as to generate an object file, wherein said wrapping function performs processes relating to said control service on behalf of said new application; and
a link step of linking said object file with a wrapping function library that includes said wrapping function so as to generate an executable program of said new application.

20. An application development recording medium used for developing a new application used in an image forming apparatus, said image forming apparatus comprising hardware resources used for image formation, an application for performing processes on image formation, and a control service that exists between said Application and said hardware resources, said application development recording medium comprising;
an application generation program for causing a computer to generate an executable program of said new application from a source file in which source code of said new application is described; and
a wrapping function library including a wrapping function that performs processes relating to said control service on behalf of said new application.

21. The application development recording medium as claimed in claim 20, wherein said wrapping function performs interprocess communication with said control service.

22. The application development recording medium as claimed in claim 20, wherein said wrapping function is executed as a wrapping thread that is generated in a process of said new application.

23. The application development recording medium as claimed in claim 20, wherein said wrapping function performs a response process to an event sent from said control service.

24. The application development recording medium as claimed in claim 20, wherein said wrapping function performs interprocess communication for every service provided by an engine control service that performs control of an engine of said image forming apparatus.

25. The application development recording medium as claimed in claim 20, wherein said wrapping function performs interprocess communication for every service provided by an memory control service that performs control of a memory of said image forming apparatus.

26. The application development recording medium as claimed in claim 20, wherein said wrapping function performs interprocess communication for services on system status notification and power source status in services provided by a system control service that performs system control of said image forming apparatus.

27. The application development recording medium as claimed in claim 20, wherein said wrapping function performs interprocess communication for services that uses a data communication protocol in services provided by a network control service that performs network control of said image forming apparatus.

28. The application development recording medium as claimed in claim 20, wherein said wrapping function performs interprocess communication for services provided by control services except for an operation panel control service that controls an operation panel in said image forming apparatus.

29. The application development recording medium as claimed in claim 20, wherein said wrapping function performs interprocess communication for a service provided by a virtual application service that is provided between said application and said control service in said image forming apparatus.

30. A method for generating a new application used in an image forming apparatus, said image forming apparatus comprising hardware resources used for image formation, an application for performing processes on image formation, and a control service that exists between said application and said hardware resources, said method comprising:
a compile step of compiling a source file of said new application in which source code for calling an application function is described so as to generate an object file, wherein said application function executes an existing application that performs interprocess communication with said control service on behalf of said new application; and
a link step of linking said object file with an application function library that includes said application function so as to generate an executable program of said new application.

31. The method as claimed in claim 30, wherein said existing application is an copy application, a printer application, a fax application, or a scanner application.

32. A computer program for causing a computer to generate a new application used in an image forming apparatus, said image forming apparatus comprising hardware resources used for image formation, an application for performing processes on image formation, and a control service that exists between said application and said hardware resources, said computer program comprising:
a compile program code means for compiling a source file of said new application in which source code for calling an application function is described so as to generate an object file, wherein said application function executes an existing application that performs interprocess communication with said control service on behalf of said new application; and
a link program code means for linking said object file with an application function library that includes said application function so as to generate an executable program of said new application.

33. A computer program generated by a method for generating a new application used in an image forming apparatus, said image forming apparatus comprising hardware resources used for image formation, an application for performing processes on image formation, and a control service that exists between said application and said hardware resources, said method comprising:
a compile step of compiling a source file of said new application in which source code for calling an application function is described so as to generate an object file, wherein said application function executes an existing application that performs interprocess communication with said control service on behalf of said new application; and
a link step of linking said object file with an application function library that includes said application function so as to generate an executable program of said new application.

34. A computer readable recording medium storing program code for causing a computer to generate a new application used in an image forming apparatus, said image forming apparatus comprising hardware resources used for image formation, an application for performing processes on image formation, and a control service that exists between said application and said hardware resources, said computer readable recording medium comprising:
a compile program code means for compiling a source file of said new application in which source code for calling an application function is described so as to generate an object file, wherein said application function executes an existing application that performs interprocess communication with said control service on behalf of said new application; and
a link program code means for linking said object file with an application function library that includes said application function so as to generate an executable program of said new application.

35. A computer readable recording medium storing a computer program generated by a method for generating a new application used in an image forming apparatus, said image forming apparatus comprising hardware resources used for image formation, an application for performing processes on image formation, and a control service that exists between said application and said hardware resources, said method comprising:
a compile step of compiling a source file of said new application in which source code for calling an application function is described so as to generate an object file, wherein said application function executes an existing application that performs interprocess communication with said control service on behalf of said new application; and
a link step of linking said object file with an application function library that includes said application function so as to generate an executable program of said new application.

36. An image forming apparatus comprising a computer program generated by a method for generating a new application used in said image forming apparatus, said image forming apparatus comprising hardware resources used for image formation, an application for performing processes on image formation, and a control service that exists between said application and said. hardware resources, said method comprising:
a compile step of compiling a source file of said new application in which source code for calling an application function is described so as to generate an object file, wherein said application function executes an existing application that performs interprocess communication with said control service on behalf of said new application; and
a link step of linking said object file with an application function library that includes said application function so as to generate an executable program of said new application.

37. An application development recording medium used for developing a new application used in an image forming apparatus, said image forming apparatus comprising hardware resources used for image formation, an application for performing processes on image formation, and a control service that exists between said application and said hardware resources, said application development recording medium comprising;
an application generation program for causing a computer to generate an executable program of said new application from a source file in which source code of said new application is described; and
an application function library including an application function that executes an existing application that performs interprocess communication with said control service on behalf of said new application.

38. The application development recording medium as claimed in claim 37, wherein said existing application is an copy application, a printer application, a fax application, or a scanner application.

39. A method for generating a new application used in an information processing apparatus, said information processing apparatus comprising hardware resources, an application for providing a user service by using said hardware resources, and a control service that exists between said application and said hardware resources, said method comprising:
a compile step of compiling a source file of said new application in which source code for calling a wrapping function is described so as to generate an object file, wherein said wrapping function performs processes relating to said control service on behalf of said new application; and
a link step of linking said object file with a wrapping function library that includes said wrapping function so as to generate an executable program of said new application.

40. The method as claimed in claim 39, wherein said wrapping function performs interprocess communication with said control service.

41. The method as claimed in claim 39, wherein said wrapping function is executed as a wrapping thread that is generated in a process of said new application.

42. The method as claimed in claim 40, wherein said wrapping function performs a response process to an event sent from said control service.

43. The method as claimed in claim 39, wherein said wrapping function performs interprocess communication for a predetermined service provided by said control service.

44. The method as claimed in claim 39, wherein said wrapping function performs interprocess communication for a service provided by a virtual application service that is provided between said application and said control service in said information processing apparatus.

45. A computer program for causing a computer to generate a new application used in an information processing apparatus, said information processing apparatus comprising hardware resources, an application for providing a user service by using said hardware resources, and a control service that exists between said application and said hardware resources, said computer program comprising:
a compile program code means for compiling a source file of said new application in which source code for calling a wrapping function is described so as to generate an object file, wherein said wrapping function performs processes relating to said control service on behalf of said new application; and
a link program code means for linking said object file with a wrapping function library that includes said wrapping function so as to generate an executable program of said new application.

46. The computer program as claimed in claim 45, wherein said wrapping function performs interprocess communication with said control service.

47. The computer program as claimed in claim 45, wherein said wrapping function is executed as a wrapping thread that is generated in a process of said new application.

48. A computer program generated by a method for generating a new application used in an information processing apparatus, said information processing apparatus comprising hardware resources, an application for providing a user service by using said hardware resources, and a control service that exists between said application and said hardware resources, said method comprising:
a compile step of compiling a source file of said new application in which source code for calling a wrapping function is described so as to generate an object file, wherein said wrapping function performs processes relating to said control service on behalf of said new application; and
a link step of linking said object file with a wrapping function library that includes said wrapping function so as to generate an executable program of said new application.

49. A computer readable recording medium storing program code for causing a computer to generate a new application used in an information processing apparatus, said information processing apparatus comprising hardware resources, an application for providing a user service by using said hardware resources, and a control service that exists between said application and said hardware resources, said computer readable recording medium comprising:
a compile program code means for compiling a source file of said new application in which source code for calling a wrapping function is described so as to generate an object file, wherein said wrapping function performs processes relating to said control service on behalf of said new application; and
a link program code means for linking said object file with a wrapping function library that includes said wrapping function so as to generate an executable program of said new application.

50. The computer readable recording medium as claimed in claim 49, wherein said wrapping function performs interprocess communication with said control service.

51. The computer readable recording medium as claimed in claim 49, wherein said wrapping function is executed as a wrapping thread that is generated in a process of said new application.

52. A computer readable recording medium storing a computer program generated by a method for generating a new application used in an information processing apparatus, said information processing apparatus comprising hardware resources, an application for providing a user service by using said hardware resources, and a control service that exists between said application and said hardware resources, said method comprising:
a compile step of compiling a source file of said new application in which source code for calling a wrapping function is described so as to generate an object file, wherein said wrapping function performs processes relating to said control service on behalf of said new application; and
a link step of linking said object file with a wrapping function library that includes said wrapping function so as to generate an executable program of said new application.

53. An information processing apparatus that includes a program generated by a method for generating a new application used in an information processing apparatus, said information processing apparatus comprising hardware resources, an application for providing a user service by using said hardware resources, and a control service that exists between said application and said hardware resources, said method comprising:
a compile step of compiling a source file of said new application in which source code for calling a wrapping function is described so as to generate an object file, wherein said wrapping function performs processes relating to said control service on behalf of said new application; and
a link step of linking said object file with a wrapping function library that includes said wrapping function so as to generate an executable program of said new application.

54. An application development recording medium used for developing a new application used in an information processing apparatus, said information processing apparatus comprising hardware resources, an application for providing a user service by using said hardware resources, and a control service that exists between said application and said hardware resources, said application development recording medium comprising;
an application generation program for causing a computer to generate an executable program of said new application from a source file in which source code of said new application is described; and
a wrapping function library including a wrapping function that performs processes relating to said control service on behalf of said new application.

55. The application development recording medium as claimed in claim 54, wherein said wrapping function performs interprocess communication with said control service.

56. The application development recording medium as claimed in claim 54, wherein said wrapping function is executed as a wrapping thread that is generated in a process of said new application.

57. The application development recording medium as claimed in claim 54, wherein said wrapping function performs a response process to an event sent from said control service.

58. The application development recording medium as claimed in claim 54, wherein said wrapping function performs interprocess communication for a predetermined service provided by said control service.

59. The application development recording medium as claimed in claim 54, wherein said wrapping function performs interprocess communication for a service provided by a virtual application service that is provided between said application and said control service in said information processing apparatus.

60. A method for generating a new application used in an information processing apparatus, said information processing apparatus comprising hardware resources, an application for providing a user service by using said hardware resources, and a control service that exists between said application and said hardware resources, said method comprising:
a compile step of compiling a source file of said new application in which source code for calling an application function is described so as to generate an object file, wherein said application function executes an existing application that performs interprocess communication with said control service on behalf of said new application; and
a link step of linking said object file with an application function library that includes said application function so as to generate an executable program of said new application.

61. A computer program for causing a computer to generate a new application used in an information processing apparatus, said information processing apparatus comprising hardware resources, an application for providing a user service by using said hardware resources, and a control service that exists between said application and said hardware resources, said computer program comprising:
a compile program code means for compiling a source file of said new application in which source code for calling an application function is described so as to generate an object file, wherein said application function executes an existing application that performs interprocess communication with said control service on behalf of said new application; and
a link program code means for linking said object file with an application function library that includes said application function so as to generate an executable program of said new application.

62. A computer program generated by a method for generating a new application used in an information processing apparatus, said information processing apparatus comprising hardware resources, an application for providing a user service by using said hardware resources, and a control service that exists between said application and said hardware resources, said method comprising:
a compile step of compiling a source file of said new application in which source code for calling an application function is described so as to generate an object file, wherein said application function executes an existing application that performs interprocess communication with said control service on behalf of said new application; and
a link step of linking said object file with an application function library that includes said application function so as to generate an executable program of said new application.

63. A computer readable recording medium storing program code for causing a computer to generate a new application used in an information processing apparatus, said information processing apparatus comprising hardware resources, an application for providing a user service by using said hardware resources, and a control service that exists between said application and said hardware resources, said computer readable recording medium comprising:
a compile program code means for compiling a source file of said new application in which source code for calling an application function is described so as to generate an object file, wherein said application function executes an existing application that performs interprocess communication with said control service on behalf of said new application; and
a link program code means for linking said object file with an application function library that includes said application function so as to generate an executable program of said new application.

64. A computer readable recording medium storing a program generated by a method for generating a new application used in an information processing apparatus, said information processing apparatus comprising hardware resources, an application for providing a user service by using said hardware resources, and a control service that exists between said application and said hardware resources, said method comprising:
a compile step of compiling a source file of said new application in which source code for calling an application function is described so as to generate an object file, wherein said application function executes an existing application that performs interprocess communication with said control service on behalf of said new application; and
a link step of linking said object file with an application function library that includes said application function so as to generate an executable program of said new application.

65. An information processing apparatus comprising a computer program generated by a method for generating a new application used in an information processing apparatus, said information processing apparatus comprising hardware resources, an application for providing a user service by using said hardware resources, and a control service that exists between said application and said hardware resources, said method comprising:
a compile step of compiling a source file of said new application in which source code for calling an application function is described so as to generate an object file, wherein said application function executes an existing application that performs interprocess communication with said control service on behalf of said new application; and
a link step of linking said object file with an application function library that includes said application function so as to generate an executable program of said new application.

66. An application development recording medium used for developing a new application used in an information processing apparatus, said information processing apparatus comprising hardware resources, an application for providing a user service by using said hardware resources, and a control service that exists between said application and said hardware resources, said application development recording medium comprising;
an application generation program for causing a computer to generate an executable program of said new application from a source file in which source code of said new application is described; and
an application function library including an application function that executes an existing application that performs interprocess communication with said control service on behalf of said new application.
